(19) United States
(12) Patent Application Publication
(10) Pub. No.: US 2025/0042775 A1
(43) Pub. Date: Feb. 6, 2025

(54) POLYIMIDE POLYMER FOR WATER TREATMENT

(71) Applicant: KING FAHD UNIVERSITY OF PETROLEUM AND MINERALS, Dhahran (SA)

(72) Inventor: Mahmoud Atef ABDULHAMID, Dhahran (SA)

(73) Assignee: KING FAHD UNIVERSITY OF PETROLEUM AND MINERALS, Dhahran (SA)

(21) Appl. No.: 18/364,897

(22) Filed: Aug. 3, 2023

(51) Int. Cl. C02F 1/28; B01D 69/02; B01D 69/10; B01D 71/56

(52) U.S. Cl. CPC C02F 1/285; B01D 69/02; B01D 69/108; B01D 71/56; B01D 2257/70; B01D 2323/219

(57) ABSTRACT

A method for separating bisphenol A (BPA) from an aqueous solution includes contacting an aqueous solution containing BPA with a polyimide polymer on a porous support; and passing at least a portion of the aqueous solution through the polyimide polymer to form a purified water permeate and a BPA residue retentate. The BPA residue retentate is present as a layer on an outside surface of the polyimide polymer. The polyimide polymer contains reacted units of a fluorinated phthalic monomer and one or more amino carboxyl aryl monomers.

### STATEMENT OF ACKNOWLEDGEMENT

This research was supported by the College of Petroleum Engineering and Geoscience at King Fahd University of Petroleum and Minerals under the project SF21012.

### STATEMENT REGARDING PRIOR DISCLOSURE BY THE INVENTORS

Aspects of this technology are described in “Carboxyl-functionalized polyimides for efficient bisphenol A removal: Influence of wettability and porosity on adsorption capacity” published in Chemosphere, Volume 313, November 2022, 137347, which is incorporated herein by reference in its entirety.

### BACKGROUND

### Technical Field

The present disclosure is directed to a polyimide polymer; particularly to a membrane containing the polyimide polymer for water treatment.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Bisphenol A (BPA) is a diphenol organic pollutant classified as an endocrine-disrupting chemical (EDC) due to its high toxicity to living organisms. Due to the chemical properties of BPA, including its moderate water solubility, heat resistance, low volatility, and solidity under normal environmental conditions, it has become one of the most widely used industrial chemicals worldwide. BPA serves as a primary raw material in producing high molecular weight materials, such as phenolic and epoxy resins, polycarbonate plastics, and food lacquer coatings. Globally, the production and consumption of BPA are substantial, with China alone producing approximately four million tons annually since 2018. Furthermore, the global market of BPA is expected to exceed seven million tons by 2023, with an average yearly growth rate of about 3% from 2017 to 2023. Humans are inadvertently and passively exposed to BPA, even at low concentrations, leading to potential harm. Consequently, BPA has been detected in various human body fluids, such as amniotic fluid, blood, breast milk, placenta, perspiration, and urine.

According to estimates from the Environmental Protection Agency (EPA), more than one billion pounds of BPA infiltrate the environment annually, indicating the scale of the issue of possible exposure. BPA primarily migrates to the environment through landfill leachates, inadequate removal during wastewater treatment, leaching from discarded BPA-based materials, and processing of BPA during production. Based on the drinking water quality standards in the United States and China, BPA concentrations must be maintained between 0.1-10 μg L⁻¹, with a health risk limit of less than 10⁻⁶ μg L⁻¹. Therefore, the removal of BPA during water purification is critical to protect aquatic life and preserve human health.

Different treatment technologies have been employed to remove BPA contaminants from wastewater, including physical, chemical, and biological treatment, as well as membrane separation, photoelectrocatalytic coagulation, adsorption, and oxidation. Among the diverse treatment methods, adsorption is one of the best available approaches due to its cost-effectiveness, simple operation, absence of intermediate components, reusability, and environmentally friendly. Common adsorbents have been used to purify water contaminated with BPA, such as nanomaterials, clays activated carbon, zeolites, metal-organic frameworks (MOFs), graphene oxide, composite polymers, synthetic polymers, and natural polymers.

Designing various adsorbents depends on addressing drawbacks such as inefficiency, high cost, low adsorption capacity, selectivity, and preparation conditions. On the other hand, the removal mechanism of BPA can be altered based on the adsorbent functionality and porosity. For instance, materials functionalized with polar groups such as carboxylic acid and hydroxyl groups may enhance BPA removal by generating hydrogen bond interactions between the adsorbent and the BPA. Moreover, the porosity of the adsorbent plays a critical role in determining the adsorption capacity and mechanisms. As the porosity increases, the adsorption capacity increases, and vice versa. Literature lacks a good understanding of the structure/property relationship between particular adsorbent and BPA removal performance. Investigating the effect of various parameters on the performance allows designing state-of-the-art adsorbents that can remove BPA efficiently at a low cost and with a minimum energy consumption.

Polymers may be promising adsorbents in wastewater treatment specifically for BPA removal due to their high surface area, good mechanical strength, unique pore size distribution, and tunability [Ipek, I., Kabay, N., Yüksel, M., 2017. Separation of bisphenol A and phenol from water by polymer adsorbents: Equilibrium and kinetics studies. J. Water Process Eng. 16, 206-211]. For instance, lignin showed its potential to be an excellent adsorbent for BPA and other organic contaminants [Şimşek, S., Ulusoy, H. I., 2018. Synthesis of a Useful and Economic Polymeric Material for Effective Removal of Bisphenol A. J. Polym. Environ. 26, 1605-1612]. Furthermore, different polymers with various molecular structures and porosity have been developed and investigated for BPA removal [Ipek, I., Kabay, N., Yüksel, M., 2017. Separation of bisphenol A and phenol from water by polymer adsorbents: Equilibrium and kinetics studies. J. Water Process Eng. 16, 206-211; Shen, R., Yan, X., Guan, Y. J., Zhu, W., Li, T., Liu, X. G., Li, Y., Gu, Z. G., 2018. One-pot synthesis of a highly porous anionic hypercrosslinked polymer for ultrafast adsorption of organic pollutants. Polym. Chem. 9, 4724-4732; and Sun, J., Jiang, X., Zhou, Y., Fan, J., Zeng, G., 2022. Microfiltration Membranes for the Removal of Bisphenol A from Aqueous Solution: Adsorption Behavior and Mechanism. Water 14, 2306]. Although a few polymers have been disclosed in the art, there still exists a need to develop novel polymeric membranes that provide enhanced pollutant removal and address environmental remediation problems.

In view of the foregoing, it is one objective of the present disclosure to describe a method for separating bisphenol A (BPA) from an aqueous solution. A second objective of the present disclosure is to describe a method of making a polyimide membrane containing a polyimide polymer. A third objective of the present disclosure is to describe a water treatment method using the polyimide membrane.

### SUMMARY

In an exemplary embodiment, a method for separating bisphenol A (BPA) from an aqueous solution, is described. The method includes contacting an aqueous solution containing BPA with a polyimide polymer on a porous support. In some embodiments, the polyimide polymer contains reacted units of a fluorinated phthalic monomer and one or more amino carboxyl aryl monomers. The method further includes passing at least a portion of the aqueous solution through the polyimide polymer to form a purified water permeate and a BPA residue retentate, wherein the BPA residue retentate is present as a layer on an outside surface of the polyimide polymer.

In some embodiments, the porous support is at least one selected from the group consisting of a polymeric support, a ceramic support, and a metallic support.

In some embodiments, the porous support is a ceramic support selected from the group consisting of an alumina support, a zirconia support, and a titania support.

In some embodiments, the polyimide polymer has a number average molecular weight (Mₙ) of 15 to 50 kilograms per mole (Kg mol⁻¹) and a weight average molecular weight (Mw) of 15 to 60 Kg mol⁻¹. In some embodiments, the polyimide polymer has a Mₙ of 80 to 120 kilograms per mole (Kg mol⁻¹) and a Mw of 100 to 150 Kg mol⁻¹.

In some embodiments, the polyimide polymer is a polycondensate of 4,4′-(hexafluoroisopropylidene) diphthalic anhydride (6FDA) and 3,5-diaminobenzoic acid (DABA) (poly (6FDA-DABA)) and a polycondensate of 6FDA and 3,5-diamino-2,4,6-trimethylbenzoic acid (TrMCA) (poly (6FDA-TrMCA)).

In some embodiments, the polyimide polymer is a polycondensate of 6FDA, DABA and TrMCA (poly (6FDA-DABA/TrMCA)), and wherein a monomer ratio of the DABA to the TrMCA is in a range of 1:10 to 1:1.

In some embodiments, the BPA is present in the aqueous solution at a concentration of 0.5 to 5 milligrams per liter (mg/L) based on a total volume of the aqueous solution.

In some embodiments, the polyimide polymer has a water contact angle of 75 to 105 degrees (°).

In some embodiments, the polyimide polymer has a specific surface area of 30 to 300 square meters per gram (m² g⁻¹).

In an exemplary embodiment, a method of making a polyimide membrane comprising a polyimide polymer is described. The method includes mixing monomers of 6FDA, DABA, TrMCA and a first solvent in the presence of a base to form a reaction mixture; heating the reaction mixture at a temperature of 180 to 220° C. thereby polymerizing monomers of 6FDA, DABA, and TrMCA to form the poly (6FDA-DABA/TrMCA) in the reaction mixture; adding a second solvent to the reaction mixture to precipitate the poly (6FDA-DABA/TrMCA); and removing the poly (6FDA-DABA/TrMCA) from the reaction mixture in the form a precipitate, washing and drying.

In some embodiments, a monomer ratio of the DABA to the TrMCA is in a range of 1:9 to 1:1.

In some embodiments, a ratio of the 6FDA monomer to a total monomers of the DABA and the TrMCA is in a range of 1:2 to 2:1.

In some embodiments, the first solvent is at least one selected from the group consisting of m-cresol, o-cresol, p-cresol, 3,4-xylenol, 2,6-xylenol, and 2,5-xylenol.

In some embodiments, the base is at least one selected from the group consisting of isoquinoline, quinoline, pyridine, piperidine, N-methylpyrrolidine, and 1,8-diazabicyclo[5.4.0]undec-7-ene (DBU).

In some embodiments, the second solvent is at least one selected from the group consisting of methanol, ethanol, n-propanol, iso-propanol, n-butanol, and tert-butanol.

In some embodiments, the method further includes mixing and dissolving the poly (6FDA-DABA/TrMCA) in a third solvent to form a polymer solution; and applying the polymer solution onto a surface of a porous support to form a polymer layer in a liquid form on the porous support and drying to form the polyimide membrane. In some embodiments, the polymer layer after the drying has an average thickness in a range of 5 to 100 micrometers (μm).

In some embodiments, the third solvent is at least one selected from the group consisting of dimethylformamide (DMF), dimethyl sulfoxide (DMSO), tetrahydrofuran (THF), and N-Methyl-2-pyrrolidone (NMP).

In an exemplary embodiment, a water treatment method is described. The method includes contacting a contaminated aqueous composition containing BPA with the polyimide membrane containing a polyimide polymer to adsorb the BPA on the polyimide membrane and form a purified aqueous composition.

In some embodiments, the water treatment method has a BPA removal efficiency of up to 90% based on an initial concentration of the BPA in the contaminated aqueous composition.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart of a method for separating bisphenol A (BPA) from an aqueous solution, according to certain embodiments;

FIG. 1B is a schematic flowchart of a method of making a polyimide membrane comprising a polyimide polymer, according to certain embodiments;

FIG. 2 shows synthetic routes for polyimides and co-polyimides preparation using polycondensation reaction of 4,4′-(hexafluoroisopropylidene) diphthalic anhydride (6FDA) with various ratios of 3,5-diaminobenzoic acid (DABA) and 3,5-diamino-2,4,6-trimethylbenzoic acid (TrMCA) at 200° C. in m-cresol, according to certain embodiments;

FIG. 3 shows ¹H nuclear magnetic resonance (NMR) spectra of 6FDA-DABA in dimethyl sulfoxide (DMSO)-d₆, according to certain embodiments;

FIG. 4 shows ¹H NMR of a polycondensate of 6FDA-TrMCA in DMSO-d₆, according to certain embodiments;

FIG. 5 shows ¹H NMR of a polycondensate of 6FDA-DABA/TrMCA (0.5/0.5) in DMSO-d₆, according to certain embodiments;

FIG. 6 shows ¹H NMR of a polycondensate of 6FDA-DABA/TrMCA (0.3/0.7) in DMSO-d₆, according to certain embodiments;

FIG. 7 shows ¹H NMR of a polycondensate of 6FDA-DABA/TrMCA (0.1/0.9) in DMSO-d₆, according to certain embodiments;

FIG. 8A shows ¹H NMR spectra of various carboxyl-functionalized 6FDA-based polyimides in DMSO-d₆, according to certain embodiments;

FIG. 8B shows Fourier-transform infrared (FTIR) spectra of the carboxyl-functionalized 6FDA-based polyimides, according to certain embodiments;

FIG. 8C shows thermal gravimetric analysis (TGA) curves of the carboxyl-functionalized 6FDA-based polyimides, according to certain embodiments;

FIG. 8D shows N₂ adsorption isotherms at −196° C. and 1 bar of the carboxyl-functionalized 6FDA-based polyimides, according to certain embodiments;

FIG. 8E shows wide-angle X-ray diffraction (WXRD) spectra of the carboxyl-functionalized 6FDA-based polyimides, according to certain embodiments;

FIG. 8F shows water-contact angle (WCA) measurements of the carboxyl-functionalized 6FDA-based polyimides, according to certain embodiments;

FIG. 9A shows a pseudo-first-order model depicting adsorption performance of BPA using the carboxyl-functionalized polymers, according to certain embodiments;

FIG. 9B shows a pseudo-second-order model depicting adsorption performance of BPA using carboxyl-functionalized polymers, according to certain embodiments;

FIG. 9C shows intra-particle diffusion model depicting adsorption performance of BPA using carboxyl-functionalized polymers, according to certain embodiments;

FIG. 9D shows liquid film diffusion model depicting adsorption performance of BPA using carboxyl-functionalized polymers, according to certain embodiments;

FIG. 9E shows water contact angle (WCA) effect on adsorption initial rate of BPA using carboxyl-functionalized polymers, according to certain embodiments;

FIG. 9F depicts Langmuir and Freundlich isotherms plots of a polycondensate of 6FDA-DABA, according to certain embodiments;

FIG. 9G depicts Langmuir and Freundlich isotherms plots of a polycondensate of 6FDA-DABA/TrMCA (0.5/0.5), according to certain embodiments;

FIG. 9H depicts Langmuir and Freundlich isotherms plots of a polycondensate of 6FDA-DABA/TrMCA (0.3/0.7), according to certain embodiments; and

FIG. 9I depicts Langmuir and Freundlich isotherms plots of a polycondensate of 6FDA-DABA/TrMCA (0.1/0.9), according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of the present disclosure are directed to a method for separating bisphenol A (BPA) from an aqueous solution using polyimide polymers that are synthesized via polycondensation reaction by reacting 4,4′-(hexafluoroisopropylidene) diphthalic anhydride (6FDA) with various ratios of 3,5-diaminobenzoic acid (DABA) and 3,5-diamino-2,4,6-trimethylbenzoic acid (TrMCA). In some embodiments, the polyimide polymers may be in the form of a membrane disposed on a porous support when contacting with the BPA-containing aqueous solution. In some further embodiments, the polyimide polymers may be in the form of adsorbent particles obtained by extruding a composition comprising the polyimide polymers. The adsorbent particles of the polyimide polymers are dispersed in the BPA-containing aqueous solution during the contacting. In some further embodiments, the adsorbent particles of the polyimide polymers may have different shapes and/or sizes, e.g., preferably in sphere shapes having an average diameter at least 5%, at least 10%, at least 20%, or even more preferably at least 40% larger than that of the average pore sizes of the filter used to separate the adsorbent particles of the polyimide polymers from the BPA-containing aqueous solution after the contacting. In some more preferred embodiment, a purified water filtrate is formed after the separation by filtration, which results in the formation of a BPA residue retentate. In some further preferred embodiments, the BPA residue contains the BPA molecules from the BPA-containing aqueous solution adsorbed on surfaces and within pores of the adsorbent particles of the polyimide polymers. Other ranges are also possible. The polyimide polymers and their homopolymer counterparts were evaluated for their potential for removing bisphenol (BPA) from an aqueous solution.

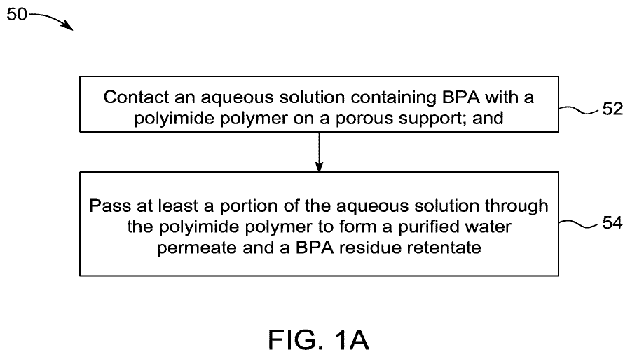

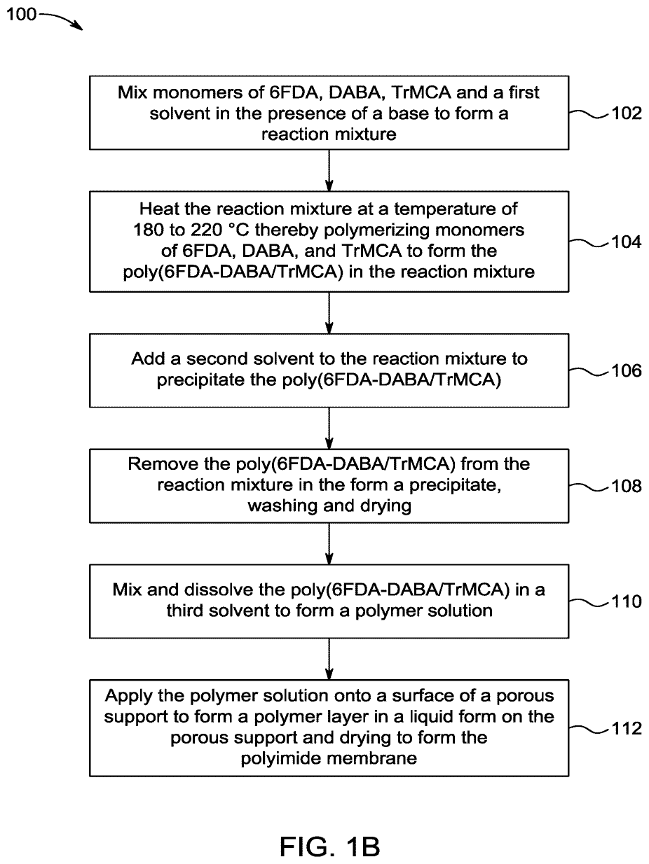

FIG. 1A illustrates a method 50 for separating bisphenol A (BPA) from an aqueous solution. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes contacting an aqueous solution containing BPA with a polyimide polymer on a porous support. In some embodiments, the aqueous solution is a solution of BPA in water. In some embodiments, the aqueous solution includes BPA at a concentration of 0.1 to 50 milligrams per liter (mg/L) based on a total volume of the aqueous solution, preferably 0.5 to 10 mg/L, preferably 1 to 5 mg/L, or even more preferably 2 to 3 mg/L. Other ranges are also possible. In some embodiments, the aqueous solution may have a pH in the range of 2 to 10, preferably a pH in the range of 3 to 9, more preferably a pH in the range of 4 to 8, even more preferably a pH in the range of 5 to 7, or a pH of about 6. Other ranges are also possible. In some embodiments, the BPA polyimide polymer is in the form of a membrane disposed on the porous support having a first side and a second side opposite the first side. In some further embodiments, only the first side of the BPA polyimide membrane is in contact with the BPA-containing solution during the BPA removal.

The polyimide polymer of the polyimide membrane includes reacted units of a fluorinated phthalic monomer and one or more amino carboxyl aryl monomers. The fluorinated phthalic monomer is a fluorinated phthalic anhydride. In a specific embodiment, the polyimide polymer is a polycondensate of 4,4′-(hexafluoroisopropylidene) diphthalic anhydride (6FDA) and 3,5-diaminobenzoic acid (DABA) (poly (6FDA-DABA)). In some embodiments, the monomer ratio of 6FDA to DABA in the polymer 6FDA-DABA is in the range of 1:5 to 5:1, preferably 1:4 to 4:1, preferably 1:3 to 3:1, preferably 1:2 to 2:1, preferably 1:1. Other ranges are also possible.

In some embodiments, the polyimide polymer is a polycondensate of the 6FDA and 3,5-diamino-2,4,6-trimethylbenzoic acid (TrMCA) (poly (6FDA-TrMCA)). In some embodiments, the monomer ratio of 6FDA to TrMCA in the polymer 6FDA-TrMCA is in the range of 1:5 to 5:1, preferably 1:4 to 4:1, preferably 1:3 to 3:1, preferably 1:2 to 2:1, preferably 1:1. Other ranges are also possible.

In some other embodiments, polyimide polymer is a polycondensate of 6FDA, DABA, and TrMCA (poly (6FDA-DABA/TrMCA)). In some preferred embodiments, the monomer ratio of the DABA to the TrMCA in the polymer 6FDA-DABA/TrMCA is in the range of 1:10 to 1:1, preferably 1:1 to 1:9. In some further embodiments, the monomer ratio of 6FDA to TrMCA in the polymer 6FDA-DABA/TrMCA is in the range of 1:5 to 5:1, preferably 1:4 to 4:1, preferably 1:3 to 3:1, preferably 1:2 to 2:1. In some further preferred embodiments, the monomer ratio of 6FDA to DBA in the polymer 6FDA-DABA/TrMCA is in the range of 15:1 to 1:1, preferably 10:1 to 2:1, preferably 8:1 to 4:1, or even more preferably about 6:1. In some most preferred embodiments, the ratio of the 6FDA monomer to the total monomers of the DABA and the TrMCA is in a range of 1:2 to 2:1, preferably 1:1. Other ranges are also possible.

In some embodiments, the polyimide polymer has a number average molecular weight (Mₙ) of 15 to 50 kilograms per mole (Kg mol⁻¹), preferably 20 to 45 Kg mol⁻¹, preferably 30 to 40 Kg mol⁻¹, or even more preferably about 35 Kg mol⁻¹. In some embodiments, the polyimide polymer has a weight average molecular weight (Mw) of 15 to 60 Kg mol⁻¹, preferably 20 to 55 Kg mol⁻¹, preferably 30 to 50 Kg mol⁻¹, or even more preferably 35 to 45 Kg mol⁻¹. Other ranges are also possible.

In some other embodiments, the polyimide polymer has a Mₙ of 80 to 120, preferably 83-117, preferably 85-115, preferably 90-110 kilograms per mole (kg mol⁻¹), and a Mw of 100 to 150, preferably 105 to 145, preferably 110 to 140, preferably 115 to 135, preferably 120 to 135, preferably 125 to 135 Kg mol⁻¹. Other ranges are also possible.

The polyimide polymer is supported on a porous support. In some embodiments, the porous support may be a polymeric support, a ceramic support, and a metallic support. In some embodiments, the porous support is a polymeric support. Examples of polymers used to make the polymeric support include cellulose acetate (CA), polyacrylonitrile (PAN), polyimide, polycarbonate (PC), polyethylene (PE), and polypropylene (PP), polytetrafluoroethylene (PTFE), and/or combinations thereof. In some embodiments, the polymeric support may be embedded with metals, metal oxides and/or carbon nanotubes (CNTs) to improve the performance of the membrane. In some embodiments, the porous support is a metallic support. The metallic support is made from metals/metal oxides thereof. Examples of metals used to make the metallic support include iron, aluminum, nickel, copper, magnesium, titanium, zinc, lead, silver, gold, platinum, tantalum, tungsten, their alloys, and steel. In a preferred embodiment, the porous support is ceramic support. The ceramic support may be made of alumina, zirconia, titania, silicon carbide, SiO₂, or combinations thereof.

At step 54, the method 50 includes passing at least a portion of the aqueous solution through the polyimide polymer in the form of a membrane to form a purified water permeate and a BPA residue retentate. The BPA containing aqueous solution passes from the first side (outside surface) of the polyimide membrane containing the polyimide polymer to the second side (inner surface) of the polyimide membrane via the pores of the polyimide membrane. The polyimide membrane selectively allows for the passage of the purified water through the pores of the membrane, while selectively retaining the BPA residue retentate. The BPA residue retentate is present as a layer on the outside surface of the polyimide membrane. In some embodiments, the layer of the BPA residue retentate has a thickness in a range of 50 nanometers (nm) to 10 millimeters (mm), preferably 1 micrometer (μm) to 1000 μm, preferably 10 to 500 μm, preferably 100 to 300 μm, or even more preferably about 200 μm. Other ranges are also possible. In some embodiments, the BPA molecules are adsorbed homogeneously onto the surfaces of the polyimide membrane forming monolayer coverage. In some embodiments, the monolayer of BPA molecules has an average thickness of less than 200 nm, preferably less than 150 nm, preferably less than 100 nm, or even more preferably less than 50 nm. Other ranges are also possible.

In some embodiments, the passing may be performed under a pressure of 0.8 to 2 barometric pressure (bar), preferably 0.9 to 1.5 bar, or even more preferably about 1 bar, at a temperature of 20 to 35 degree Celsius (° C.), preferably 22 to 30° C., or even more preferably about 25° C. Other ranges are also possible.

The water contact angle was obtained by the sessile drop method on the polyimide membrane surface by using a contact angle goniometer instrument, e.g., DM-501, Kyowa Interface Science Co. Ltd., Japan. The water contact angle WCA was taken on at least two, preferably at least four different positions on the polyimide membrane and the average value was recorded. The thickness of the membranes was recorded by taking measurements from at least 5, preferably at least 10 different spots on the polyimide membrane to generate corresponding data using LITEMATIC VL-50A, manufactured by Mitutoyo measuring instrument.

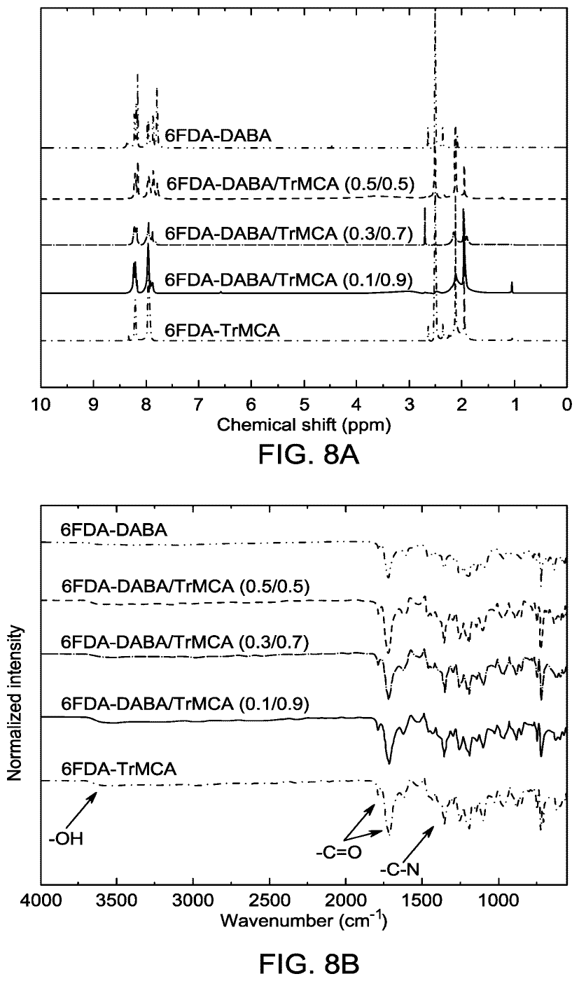

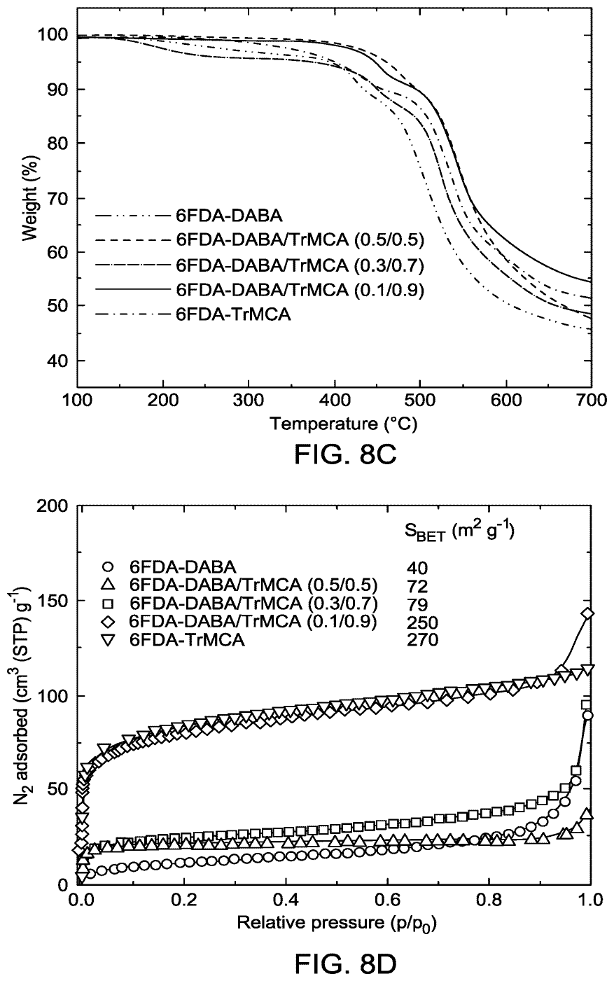

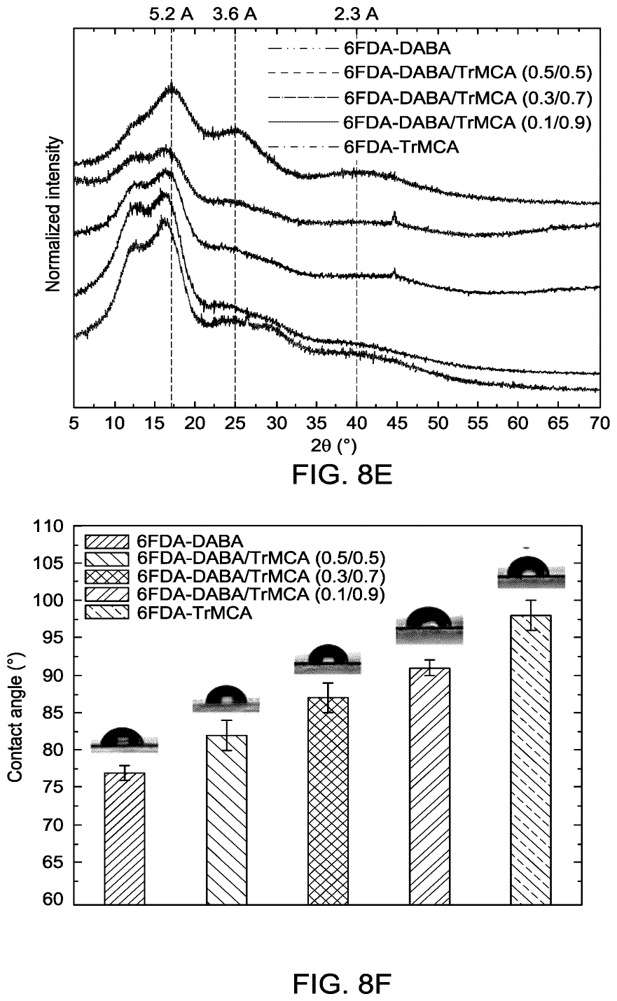

Referring to FIG. 8F, in some embodiments, the polyimide polymer containing poly (6FDA-DABA) has a water contact angle of 75 to 80 degrees (°), preferably 76 to 79°, or even more preferably 77 to 78°. In some further embodiments, the polyimide polymer containing poly (6FDA-TrMCA) has a water contact angle of 95 to 105 degrees (°), preferably 97 to 102°, or even more preferably 99 to 100°, as depicted in FIG. 8F. In some preferred embodiments, the polyimide polymer containing poly (6FDA-DABA/TrMCA) has a water contact angle of 80 to 95 degrees (°), preferably 85 to 90°, or even more preferably 86 to 89°, as depicted in FIG. 8F. Other ranges are also possible.

Referring to FIG. 1B, a method 100 of making a polyimide membrane comprising a polyimide polymer, is described. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes mixing monomers of 6FDA, DABA, TrMCA and a first solvent in the presence of a base to form a reaction mixture. The monomers are mixed in the first solvent preferably in the presence of a base to form the reaction mixture. The monomer ratio of the DABA to the TrMCA in the reaction mixture is in the range of 1:9 to 1:1, preferably 1:7 to 1:3, or even more preferably about 1:5. In some embodiments, the monomer ratio of 6FDA to TrMCA in the reaction mixture, is in the range of 1:5 to 5:1, preferably 1:4 to 4:1, preferably 1:3 to 3:1, preferably 1:2 to 2:1. In some further embodiments, the monomer ratio of DABA to the TrMCA in the polymer 6FDA-DABA/TrMCA is in the range of 1:1 to 1:9, and the monomer ratio of 6FDA to TrMCA in the reaction mixture is in the range of 1:5 to 5:1, preferably 1:4 to 4:1, preferably 1:3 to 3:1, preferably 1:2 to 2:1. The ratio of the 6FDA monomer to the total monomers of the DABA and the TrMCA is in a range of 1:2 to 2:1, preferably 1:1. Other ranges are also possible.

The first solvent is one or more of m-cresol, o-cresol, p-cresol, 3,4-xylenol, 2,6-xylenol, and 2,5-xylenol. In a preferred embodiment, the first solvent is m-cresol. In some further embodiments, the base is preferably one or more of isoquinoline, quinoline, pyridine, piperidine, N-methylpyrrolidine, (NMP), and 1,8-diazabicyclo[5.4.0]undec-7-ene (DBU). In a preferred embodiment, the base is isoquinoline. In some embodiments, the base is present in the reaction mixture at a concentration of 0.1 to 10 mol % based on a total mole number of 6FDA, DABA and TrMCA, preferably about 0.5 to 5 mol %, preferably about 1 to 3 mol %, or even more preferably about 2 mol %, based on the total mole number of 6FDA, DABA and TrMCA.

At step 104, the method 100 includes heating the reaction mixture at a temperature of 180 to 220° C. thereby polymerizing monomers of 6FDA, DABA, and TrMCA to form the poly (6FDA-DABA/TrMCA) in the reaction mixture. In some embodiments, the reaction mixture is heated to a temperature range of 180 to 220° C., preferably 185-215° C., preferably 190-210° C., preferably 195 to 205° C., preferably 200° C. for a period of 1-10 hours, preferably 2-9 hours, preferably 3-8 hours, preferably 4-7 hours, preferably 6 hours, to form the poly (6FDA-DABA/TrMCA) in the reaction mixture. Optionally, a catalyst may be used to facilitate the polymerization process.

At step 106, the method 100 includes adding a second solvent to the reaction mixture to precipitate the poly (6FDA-DABA/TrMCA). The poly (6FDA-DABA/TrMCA) is precipitated by adding the second solvent to the reaction mixture. The second solvent is one more of methanol, ethanol, n-propanol, iso-propanol, n-butanol, and tert-butanol. In a preferred embodiment, the second solvent is methanol. In some embodiments, any poor solvent and/or non-solvent/may be used to carry out the precipitation process.

At step 108, the method 100 includes removing the poly (6FDA-DABA/TrMCA) from the reaction mixture in the form of a precipitate, washing, and drying. The precipitated polymer, poly (6FDA-DABA/TrMCA), is removed from the reaction mixture by filtration and washed several times to remove impurities, unreacted monomers, and m-cresol. The washed precipitate is further dried to a temperature range of 80-150° C., preferably 85-140° C., preferably 90 to 130° C., preferably 100-125° C., and preferably 110-120° C., for complete evaporation of solvents. It is preferred to carry out the drying under a vacuum, preferably in a vacuum oven, to prevent oxidation of the polymer on exposure to air.

At step 110, the method 100 includes mixing and dissolving the poly (6FDA-DABA/TrMCA) in a third solvent to form a polymer solution. The third solvent is at least one selected from the group consisting of dimethylformamide (DMF), dimethyl sulfoxide (DMSO), tetrahydrofuran (THF), and N-methyl-2-pyrrolidone (NMP). In a preferred embodiment, the third solvent is THF. This step is carried out for the purification of the polymer poly (6FDA-DABA/TrMCA). Optionally, other purification techniques, such as chromatography, dialysis, etc., may be carried out to purify the polymer, poly (6FDA-DABA/TrMCA).

At step 112, the method 100 includes applying the polymer solution onto a surface of a porous support to form a polymer layer in a liquid form on the porous support and drying to form the polyimide membrane. The porous support with the polymer layer in the liquid form is further dried for 15-30 hours, preferably 20-25 hours, at 120-180° C., preferably 130-170° C., preferably 140-160° C., preferably 150° C. It is preferred to carry out the drying under a vacuum, preferably in a vacuum oven, to prevent oxidation of the polymer on exposure to air. The polymer layer after the drying has an average thickness in a range of 5 to 100 micrometers (μm), preferably 10 to 90 μm, preferably 20 to 70, preferably 30 to 60 μm, or even more preferably 40 to 50 μm. Other ranges are also possible.

In some embodiments, the polyimide membrane of the present disclosure has a water contact angle of 75 to 105 degrees (°) preferably 80 to 100°, preferably 85 to 95°, or even more preferably about 90°.

The structures of the polyimide membranes of the present disclosure may be characterized by Fourier-transform infrared spectroscopy (FT-IR), respectively. In some embodiments, the FT-IR are collected in a Nicolet 6700 series acquired in a range of 4500 to 400 centimeter inverse (cm⁻¹) at 4 cm⁻¹ resolution. At least 5, at least 10, or preferably at least 20 scans were carried out for each sample. In some embodiments, the polyimide membrane containing the polyimide polymers has peaks at 500 to 750 cm⁻¹, 750 to 100 cm⁻¹, 1100 to 1500 cm⁻¹, 1650 to 1800 cm⁻¹, and 3500 to 4000 cm⁻¹, in the FT-IR spectrum, confirming its formation as depicted in FIG. 8B.

The thermostability of the polyimide membrane of the present disclosure was characterized by thermal gravimetric analysis (TGA). TGA analysis is performed by using a thermogravimetric analyzer (SDT Q 600, TA Instruments, New Castle, USA). For the TGA analysis, the samples are measured by heating at an increment frequency of 5 to 20° C./min with the flow of nitrogen in a range of 25 to 150 mL/min, and a temperature of up to 1200° C. Other ranges are also possible.

Referring to FIG. 8C a thermogravimetric analyzer (TGA) curve of the polyimide polymers. In some embodiments, the polyimide polymer has a mass loss of up to 10 wt. % based on an initial weight of the polyimide polymer at a temperature of less than or equal to 400° C., as depicted in FIG. 8C. In some further embodiments, the polyimide polymer has a mass loss of up to 60 wt. % based on an initial weight of the polyimide polymer at a temperature of less than or equal to 700° C., as depicted in FIG. 8C.

As used herein, the term “N₂ adsorption/desorption method” generally refers to a technique used to measure the specific surface area of a solid material, such as a catalyst or a porous material. In some embodiments, the polyimide polymer is exposed to a stream of nitrogen gas at low temperature and pressure. The nitrogen gas is adsorbed onto the surface of the polyimide polymer, filling the pores and creating a monolayer of adsorbed nitrogen. In some further embodiments, the amount of nitrogen adsorbed at a given pressure is measured using a gas adsorption instrument, such as a BET instrument. In some preferred embodiments, the BET analysis is performed on a BELSORP analyzer according to the software manual, pages 62 to 66, manufactured by Bell Japan. In some more preferred embodiments, the nitrogen gas is gradually removed from the polyimide polymer, causing the desorption of the adsorbed nitrogen. The amount of nitrogen desorbed at a given pressure is also measured using the gas adsorption instrument. By analyzing the amount of nitrogen adsorbed and desorbed, the specific surface area of the polyimide polymer can be calculated using the BET (Brunauer-Emmett-Teller) and Barrett, Joyner and Halenda (BJH) equation.

In some embodiments, the polyimide polymer of the present disclosure has a specific surface area of 30 to 300 square meters per gram (m² g⁻¹), preferably 40 to 270 m² g⁻¹, preferably 70 to 250 m² g⁻¹, or even more preferably 90 to 250 m² g⁻¹. Other ranges are also possible.

The crystalline structures of the polyimide polymers may be characterized by X-ray diffraction (XRD). In some embodiments, the XRD may be a wide-angle XRD. The XRD patterns are collected in a Rigaku MiniFlex diffractometer equipped with a Cu-Kα radiation source (2=0.15406 nm) for a 20 range extending between 5 and 80°, preferably 15 and 70°, further preferably 30 and 60° at an angular rate of 0.005 to 0.04° s⁻¹, preferably 0.01 to 0.03° s⁻¹, or even preferably 0.02° s⁻¹. In some embodiments, the polyimide polymer has at least a first intense peak with a 2 theta (θ) value in a range of 10 to 20°, preferably about 17.5°, as depicted in FIG. 8E. In some further embodiments, the polyimide polymer has at least a second intense peak with a 2 theta (θ) value in a range of 20 to 30°, preferably about 25°, as depicted in FIG. 8E. In some preferred embodiments, the polyimide polymer has at least a third intense peak with a 2 theta (θ) value in a range of 35 to 45°, preferably about 40°, as depicted in FIG. 8E. Other ranges are also possible.

¹H and ¹³C NMR spectra may be recorded on a 400 MHz spectrometer (Bruker AvanceIII) using the residual DMSO-d₆ at δ 2.50 ppm and ¹³C DMSO-d₆ signal at δ 39.52 ppm as internal standards.

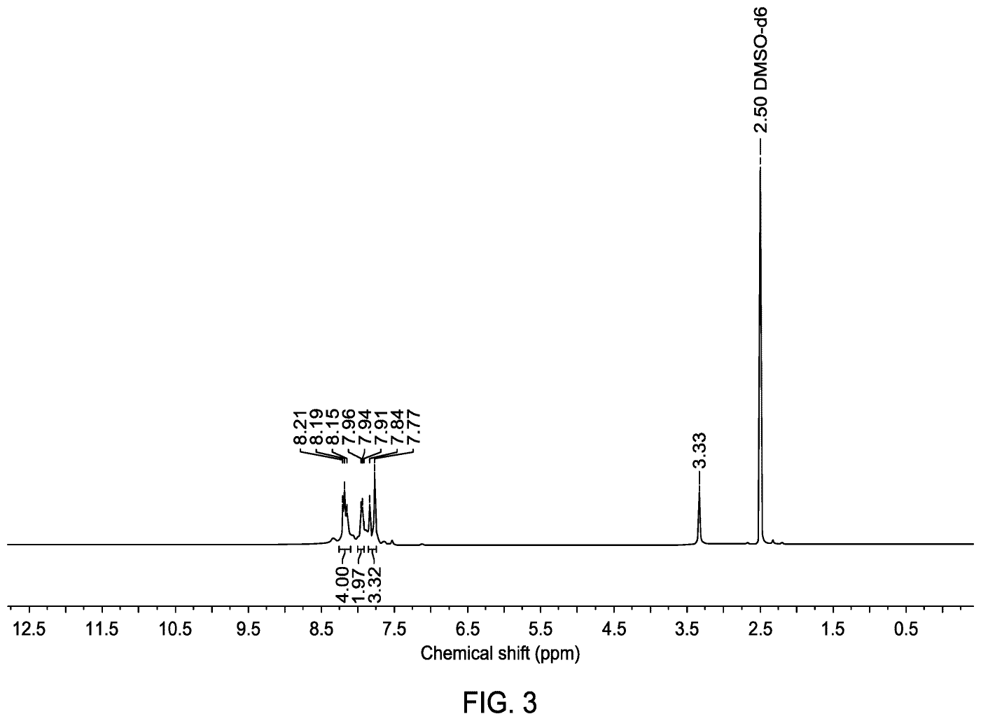

Referring to FIG. 3, ¹H nuclear magnetic resonance (NMR) spectra of the in DMSO-d₆. In some embodiments, the polycondensate of 6FDA-DABA has peaks at about 7.77 ppm, about 7.87 ppm, about 7.95 ppm, and about 8.15 to 8.21 ppm, as depicted in FIG. 3. Other ranges are also possible.

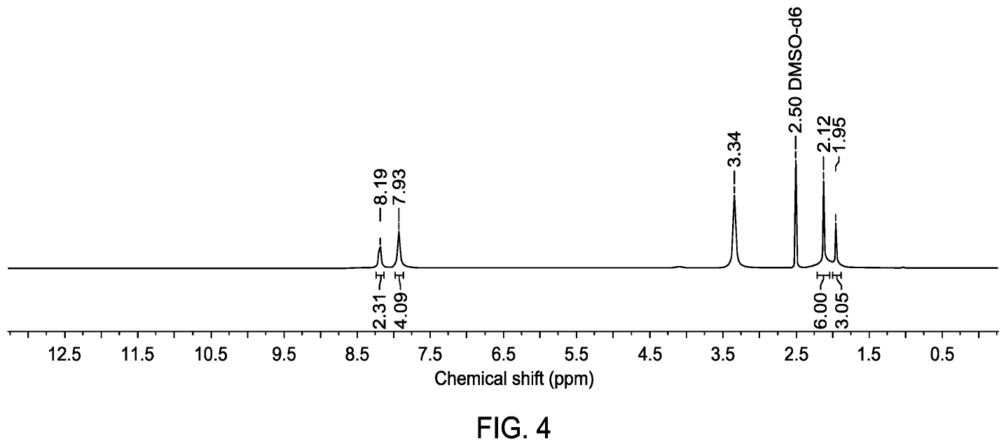

Referring to FIG. 4, ¹H nuclear magnetic resonance (NMR) spectra of the in DMSO-d₆. In some embodiments, the polycondensate of 6FDA-TrMCA has peaks at about 1.95 ppm, about 2.12 ppm, about 7.93 ppm, and about 8.19 ppm, as depicted in FIG. 4. Other ranges are also possible.

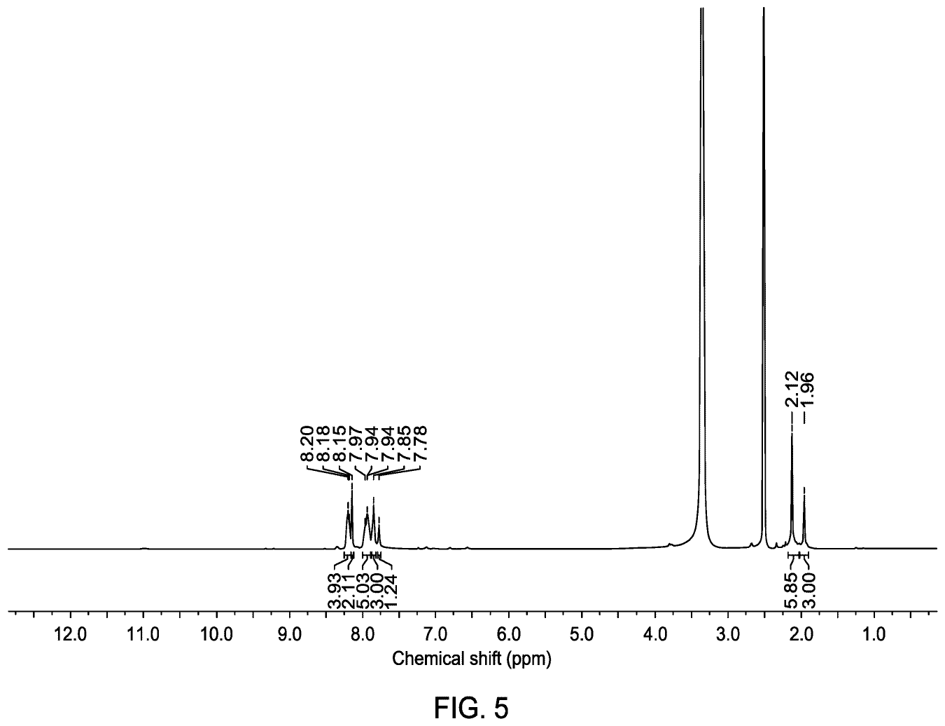

Referring to FIG. 5, ¹H nuclear magnetic resonance (NMR) spectra of the in DMSO-d₆. In some embodiments, the polycondensate of 6FDA-DABA/TrMCA in a mole ratio of 2:1:1 has peaks at about 1.96 ppm, about 2.12 ppm, about 7.78 ppm, about 7.85 ppm, about 7.94 to 7.97 ppm, about 8.15 ppm, and about 8.18 to 8.20 ppm, as depicted in FIG. 5. Other ranges are also possible.

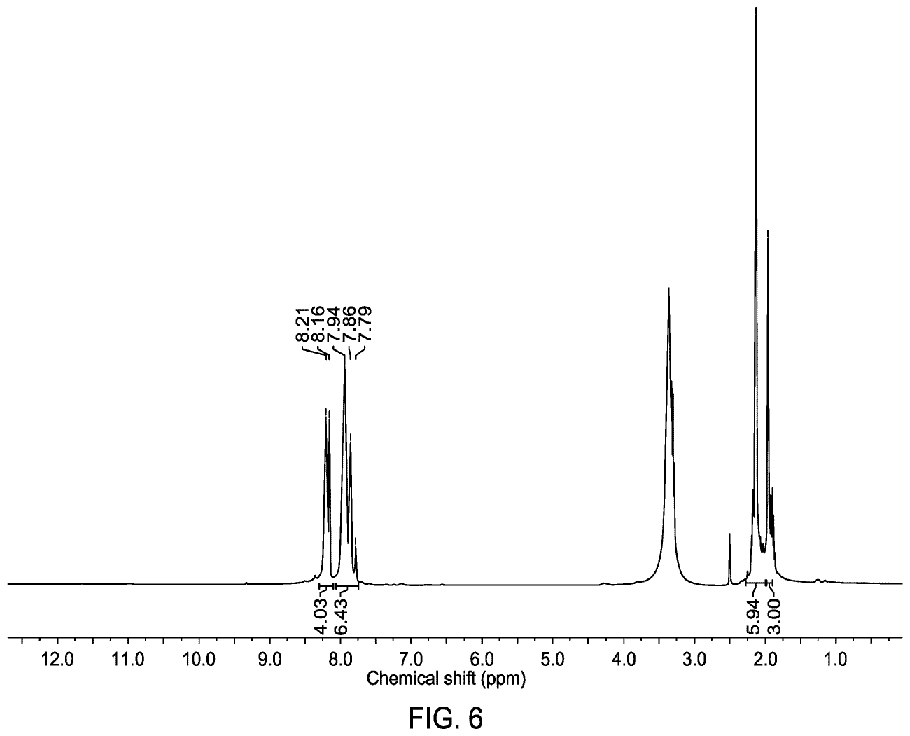

Referring to FIG. 6, ¹H nuclear magnetic resonance (NMR) spectra of the in DMSO-d₆. In some embodiments, the polycondensate of 6FDA-DABA/TrMCA in a mole ratio of 10:3:7 has peaks at about 1.97 ppm, about 2.13 ppm, about 7.79 to 7.94 ppm, and about 8.16 to 8.21 ppm, as depicted in FIG. 6. Other ranges are also possible.

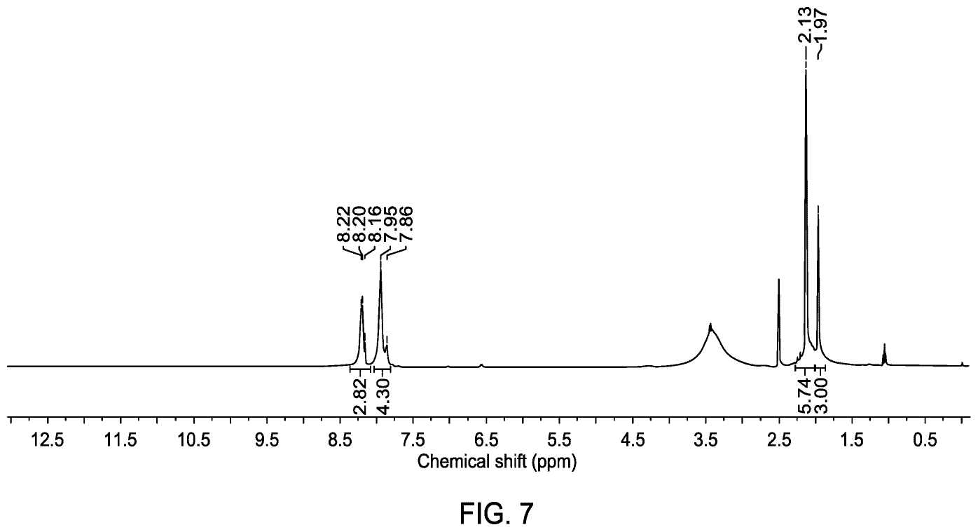

Referring to FIG. 7, ¹H nuclear magnetic resonance (NMR) spectra of the in DMSO-d₆. In some embodiments, the polycondensate of 6FDA-DABA/TrMCA in a mole ratio of 10:1:9 has peaks at about 1.97 ppm, about 2.13 ppm, about 7.86 to 7.95 ppm, and about 8.16 to 8.22 ppm, as depicted in FIG. 7. Other ranges are also possible.

A water filtration method is described. The method includes contacting a contaminated aqueous composition containing BPA with the polyimide membrane, including the polyimide polymer. The polyimide polymer selectively adsorbs the BPA on the polyimide membrane and allows for the passage of the purified water through the pores of the membrane to form a purified aqueous solution. The degree of adsorption of the BPA to the polyimide membrane is dependent on the percentage of monomer 6FDA, DABA, TrMCA in the polymer. The polyimide membrane of the present disclosure demonstrates a BPA removal efficiency of up to 90% based on an initial concentration of the BPA in the contaminated aqueous composition. In some embodiments, the BPA molecules are adsorbed homogeneously on the polyimide polymers of the polyimide membrane via one or more carboxylic acid groups of the polyimide polymers. Furthermore, one or more hydroxyl groups of the BPA molecules interact with the one or more carboxylic acid groups of the polyimide polymers, resulting in the formation of one or more hydrogen bonds.

Polyimide polymers with varying porosities, hydrophilicity, and methyl group contents were fabricated to examine their applications in BPA removal. For instance, the polycondensate of 6FDA-DABA has a BPA adsorption capacity with a maximum adsorption of about 67 mg g⁻¹ and removal efficiency of approximately 90% based on the initial concentration of the BPA containing aqueous solution. The anti-synergistic regime was observed between polymer porosity and hydrophilicity. As the content of the methyl group increases, the Brunauer-Emmett-Teller (BET) surface area increases, and the polymer hydrophilicity decreases, leading to a notable reduction in BPA adsorption capacity.

The adsorption kinetics isotherms of BPA on 6FDA-based polyimides followed the pseudo-first-order kinetics, except for the polycondensate of 6FDA-DABA, which was found to follow the pseudo-second-order. The BPA removal capacity was determined using both Langmuir and Freundlich isotherm models. The Langmuir model was more suitable than the Freundlich for the adsorption of BPA on the carboxyl functionalized polyimides. The polyimide polymers of the present disclosure represent the examples of utilizing polyimides for BPA removal.

### EXAMPLES

The following examples describe and demonstrate exemplary embodiments of the membrane as described herein. The examples are provided solely for the purpose of illustration and are not to be construed as limitations of the present disclosure, as many variations thereof are possible without departing from the spirit and scope of the present disclosure.

### Example 1: Synthesis of Polyimides and Copolyimides

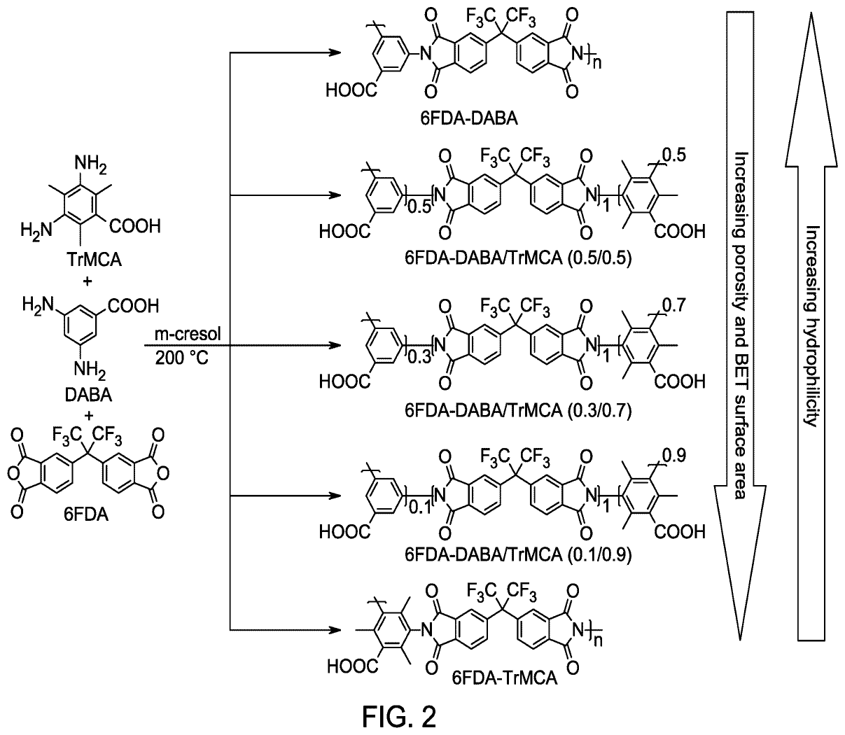

Polymers reported in this work might be prepared using a polycondensation reaction at 200° C. in m-cresol with the presence of isoquinoline, as depicted in FIG. 2. The diamines (i.e., 3,5-diaminobenzoic acid (DABA) and 3,5-diamino-2,4,6-trimethylbenzoic acid (TrMCA)) and the dianhydride, 4,4′-(hexafluoroisopropylidene) diphthalic anhydride (6FDA) were added, e.g., preferably in an equimolar amount, to a two-neck round bottom flask, followed by the addition of m-cresol under an inert atmosphere (N₂), as shown in Table 1. The reaction was heated gradually to 200° C. to ensure the total conversion of poly (amic acid) to polyimides. Afterward, the reaction was cooled down and poured onto methanol to obtain polyimide powder. The powder was reprecipitated from THE to remove residual impurities and dried in the vacuum oven at about 120° C. for about 24 hours.

TABLE 1
Polymer designation and monomer ratios used to
prepare polyimides and copolyimides.

| Polymer | 6FDA | DABA | TrMCA |
|---|---|---|---|
| 6FDA-DABA | 1.0 | 1.0 | 0 |
| 6FDA-DABA/TrMCA (0.5/0.5) | 1.0 | 0.5 | 0.5 |
| 6FDA-DABA/TrMCA (0.3/0.7) | 1.0 | 0.3 | 0.7 |
| 6FDA-DABA/TrMCA (0.1/0.9) | 1.0 | 0.1 | 0.9 |
| 6FDA-TrMCA | 1.0 | 0 | 1.0 |

6FDA-DABA (2.2 g, yield: 97%): ¹H NMR (400 MHZ, DMSO-d₆): 7.77 (m, 2H), 7.84 (s, ¹H) 7.95 (d, 2H, J=6.4 Hz), 8.15-8.21 (m, 4H). FT-IR (powder, v, cm⁻¹): 3450-3700 (—OH, str), 1784 (C═O asym, str), 1721 (C═O sym, str), 1352 (C—N, str), 719 (imide-ring deformation).

6FDA-TrMCA (2.0 g, yield: 96%): ¹H NMR (400 MHz, DMSO-d₆): 1.95 (s, 3H), 2.12 (s, 6H), 7.93 (m, 4H), 8.19 (m, 2H). FT-IR (powder, v, cm⁻¹): 3450-3700 (—OH, str), 1786 (C═O asym, str), 1715 (C═O sym, str), 1350 (C═N, str), 717 (imide-ring deformation).

6FDA-DABA/TrMCA (0.5/0.5) (1.5 g, yield: 93%): ¹H NMR (400 MHZ, DMSO-d₆): 1.96 (s, 3H), 2.12 (s, 6H), 7.78 (br s, ¹H), 7.85 (m, 3H), 7.94-7.97 (m, 5H), 8.15 (s, 2H), 8.18-8.20 (m, 4H). FT-IR (powder, v, cm⁻¹): 3450-3700 (—OH, str), 1788 (C═O asym, str), 1722 (C═O sym, str), 1350 (C—N, str), 721 (imide-ring deformation).

6FDA-DABA/TrMCA (0.3/0.7) (1.7 g, yield: 94%): ¹H NMR (400 MHZ, DMSO-d₆): 1.97 (s, 3H), 2.13 (s, 6H), 7.79-7.94 (m, 6H), 8.16-8.21 (m, 4H). FT-IR (powder, v, cm⁻¹): 3450-3700 (—OH, str), 1790 (C—O asym, str), 1715 (C—O sym, str), 1352 (C—N, str), 718 (imide-ring deformation).

6FDA-DABA/TrMCA (0.1/0.9) (1.65 g, yield: 95%): ¹H NMR (400 MHZ, DMSO-d₆): 1.97 (s, 3H), 2.13 (s, 6H), 7.86-7.95 (m, 4H), 8.16-8.22 (m, 3H). FT-IR (powder, v, cm⁻¹): 3450-3700 (—OH, str), 1786 (C═O asym, str), 1715 (C—O sym, str), 1350 (C—N, str), 721 (imide-ring deformation).

### Example 2: Polymer Synthesis and Characterization

6FDA-based polyimides (homo and copolymers) were prepared by polycondensation reaction by reacting 6FDA with DABA and TrMCA at 200° C. in m-cresol with the presence of isoquinoline by steady heating from room temperature to 200° C., over 6 hours. The obtained viscous solutions of polyimides were precipitated in methanol, filtered, and dried in the vacuum oven at 120° C. Further polymer purification was achieved by reprecipitating the polymers from their THE solution. The pure polymer powder was dried for 24 hours at 150° C. in the vacuum oven. The five polymers were soluble in polar aprotic solvents, including NMP, DMF, DMSO, and THF, and demonstrated solvent resistance towards chlorinated solvents, alcohols, and water (Table 2).

TABLE 2
Carboxyl-functionalized 6FDA-based polyimides solubility in different solvents.

| | Solubility | | | | | | | | |
|---|---|---|---|---|---|---|---|---|---|
| | | | | | | m- | | | |
| Polymer | Acetone | THF | DMF | DMSO | NMP | cresol | CHCl₃ | DCM | MeOH |
| 6FDA- | ++ | ++ | ++ | ++ | ++ | ++ | −− | −− | −− |
| DABA | | | | | | | | | |
| 6FDA- | ++ | ++ | ++ | ++ | ++ | ++ | −− | −− | −− |
| DABA/ | | | | | | | | | |
| TrMCA | | | | | | | | | |
| (0.5/0.5) | | | | | | | | | |
| 6FDA- | ++ | ++ | ++ | ++ | ++ | ++ | −− | −− | −− |
| DABA/ | | | | | | | | | |
| TrMCA | | | | | | | | | |
| (0.3/0.7) | | | | | | | | | |
| 6FDA- | ++ | ++ | ++ | ++ | ++ | ++ | −− | −− | −− |
| DABA/ | | | | | | | | | |
| TrMCA | | | | | | | | | |
| (0.1/0.9) | | | | | | | | | |
| 6FDA- | ++ | ++ | ++ | ++ | ++ | ++ | −− | −− | −− |
| TrMCA | | | | | | | | | |

The complete conversion to polyimides from poly (amic acid) was verified by the nonappearance of peaks above 10 ppm in ¹H NMR (FIGS. 3 to 7). Moreover, the chemical structures of 6FDA-based polyimides were confirmed by ¹H NMR and FTIR. From ¹H NMR, peaks at 1.95 and 2.12 ppm represent aliphatic hydrogens (—CH₃ groups) existing on TrMCA monomer. Moreover, peaks at 7.93 and 8.20 ppm signify the hydrogens on the aromatic ring of the 6FDA unit. However, peaks at 7.78 and 7.85 ppm denote the aromatic hydrogens existing on the DABA unit (FIG. 8A). The FTIR spectra verified the different functional groups in the polyimide, confirming the molecular structure. For instance, all carboxyl-functionalized polyimides displayed-OH absorption band, resulting from —COOH, in the range of 3450-3700 cm⁻¹. Moreover, the asymmetric and symmetric absorption bands of carbonyl groups (from —COOH and —CON—) were obtained in 1784-1790 and 1715-1722 cm⁻¹, respectively, whereas the C—N absorption bands were detected at 1350 cm⁻¹ (FIG. 8B). FIG. 8C represents the thermal gravimetric analysis (TGA) of the synthesized carboxyl-functionalized copolyimides and their homopolymer counterparts. All copolyimides displayed excellent thermal stability with 5% decomposition temperature (T_{d.5%}) exceeding 370° C. All polymers demonstrated a two-stage decomposition profile, where the first stage is ascribed to the decomposition of the —COOH functional group, while, the second stage is denoted by polymer backbone degradation [Abdulhamid, M. A., Genduso, G., Ma, X., Pinnau, I., 2021. Synthesis and characterization of 6FDA/3,5-diamino-2,4,6-trimethylbenzenesulfonic acid-derived polyimide for gas separation applications. Sep. Purif. Technol. 257, 117910, which is incorporated herein by reference in its entirety]. 6FDA-DABA exhibited the least carbon content (45%) after decomposition at 700° C., relative to 6FDA-TrMCA and the copolymers, due to the absence of methyl groups which increases the overall carbon content.

To measure the porosity of the carboxyl-functionalized copolyimides, BET surface area analysis was conducted using N₂ at −196° C. and 1 bar. FIG. 8D shows the N₂ adsorption isotherms of the copolyimides relative to their homopolymers (i.e., 6FDA-DABA and 6FDA-TrMCA). 6FDA-DABA exhibited the lowest BET surface area of 40 m² g⁻¹, while 6FDA-TrMCA demonstrated the highest BET surface area of 270 m² g⁻¹ in this series (Table 3).

TABLE 3
Physical properties of 6FDA-based
carboxyl-functionalized polyimides

| | Mₙ | M_{w} | PDI | T_{d,5%} | SBET |
|---|---|---|---|---|---|
| Polymer | (Kg mol⁻¹) | (Kg mol⁻¹) | (—) | (° C.) | (m² g⁻¹) |
| 6FDA-DABA | 44 | 48 | 1.08 | 392 | 40 |
| 6FDA- | 92.5 | 127 | 1.37 | 460 | 72 |
| 6FDA- | 94.3 | 126 | 1.33 | 368 | 79 |
| 6FDA- | 108 | 133.6 | 1.23 | 447 | 250 |
| 6FDA-TrMCA | 22 | 25.5 | 1.16 | 400 | 270 |

Moreover, it could be seen that the BET surface area increases as the ratio of TrMCA in the polymer increases due to the presence of methyl groups ortho to the imide linkage, which prohibits the imide bond rotation and enhances the polymer rigidity and thus porosity. Furthermore, the results obtained from PXRD spectra were aligned with the BET results (FIG. 8E). 6FDA-DABA exhibited one prominent broad peak at 20=17°, which corresponds to a d-spacing of 5.2 Å, and two minor peaks at 2θ=25 and 40°, which corresponds to a d-spacing of 3.6 and 2.3 Å, respectively. After incorporating the TrMCA unit into the polyimide backbone, the peaks shifted towards a smaller 20 and larger d-spacing, indicating an increment in space between polymer chains, thus an increase in porosity.

Furthermore, the effect of increasing methyl group content in the polymer on the polyimide's wettability is depicted in FIG. 8F. The increase in TrMCA ratio led to a change in polymer hydrophilicity. For instance, 6FDA-DABA with no methyl groups demonstrated the lowest water contact angle (WCA) of 77°, while the contact angle increased by 10% upon incorporating TrMCA with a ratio of 0.5. Moreover, 6FDA-TrMCA with three methyl groups displayed the highest WCA of 96° relative to the other polymers. The incorporation of methyl groups significantly improved the polymer porosity. However, it reduced its hydrophilicity, making the polymers less dispersed in water, affecting their adsorption capacity. The effect of increasing porosity using aliphatic groups while varying hydrophilicity on bisphenol A removal capacities was also investigated.

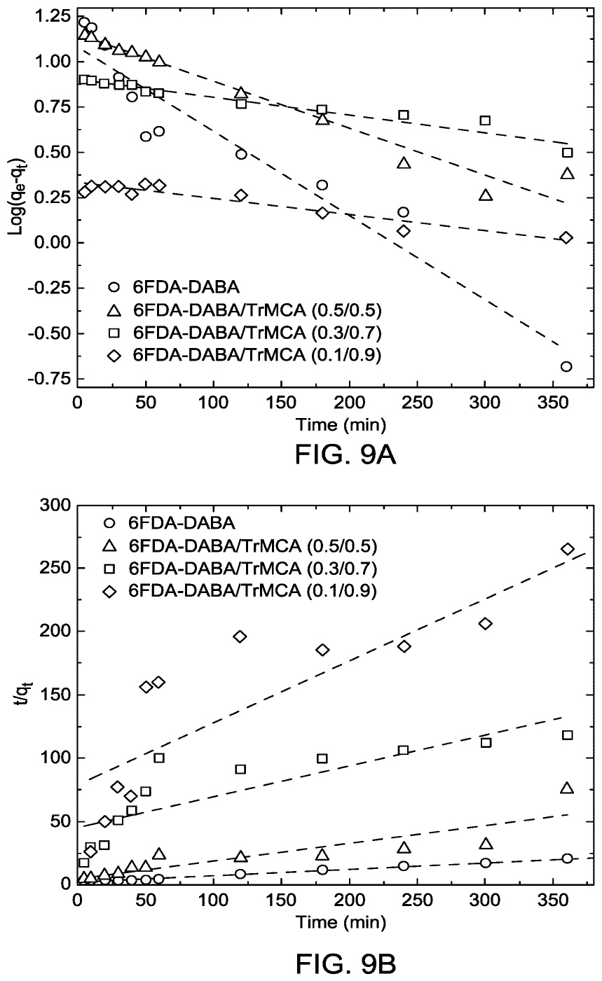

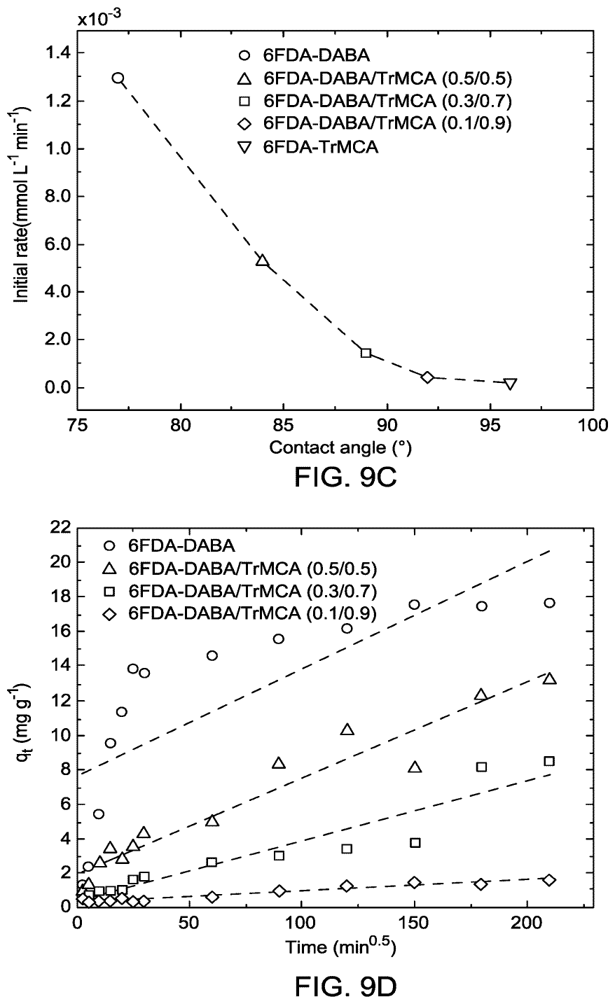

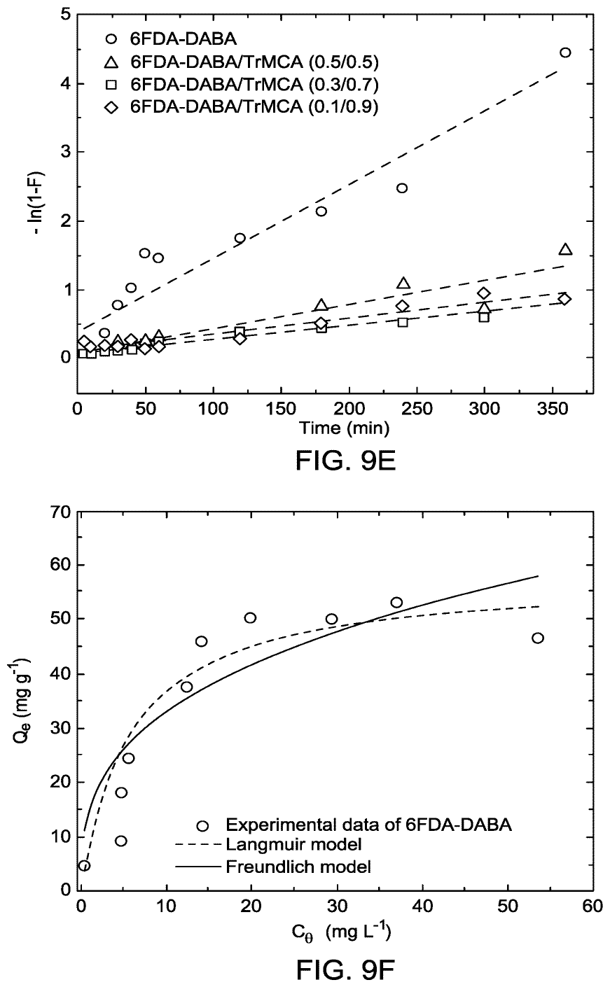

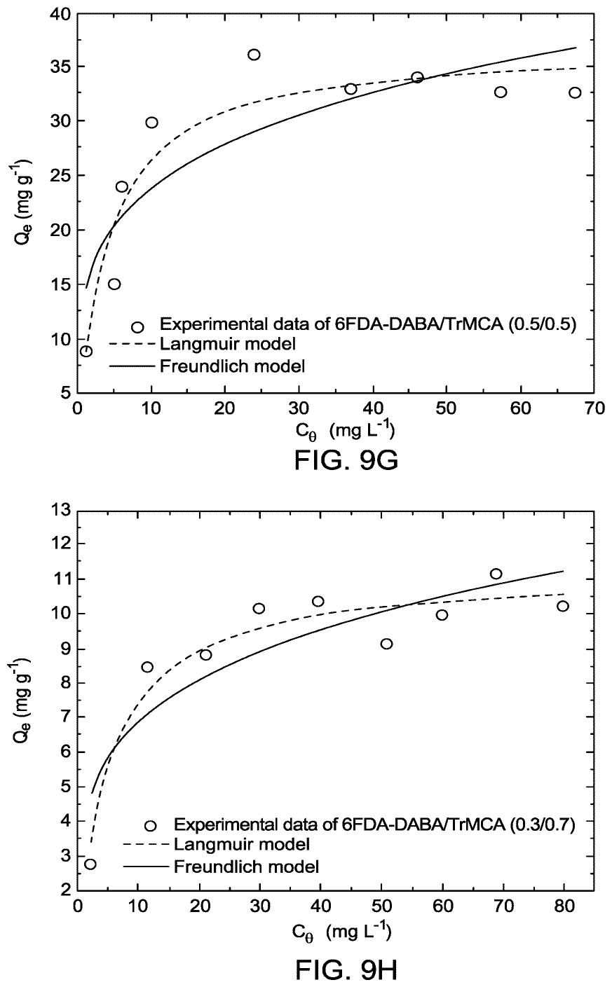

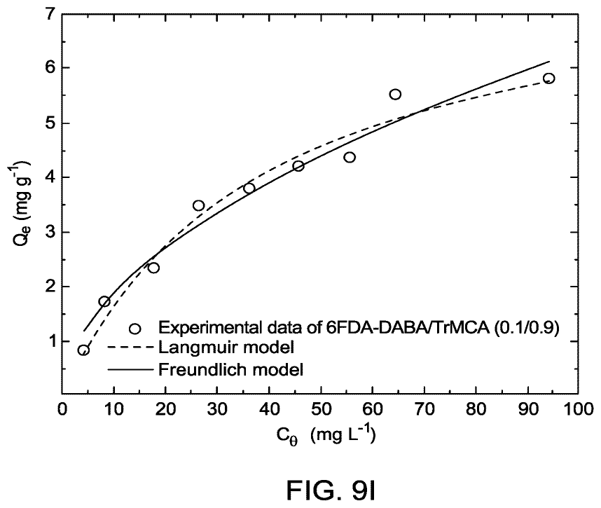

The adsorption performance of the carboxyl-functionalized 6FDA-based polyimides was evaluated by establishing kinetic, and adsorption isotherms study. The adsorption kinetics is essential for designing adsorption systems and reactors [Wang, J., Guo, X., 2020. Adsorption kinetic models: Physical meanings, applications, and solving methods. J. Hazard. Mater. 390, 122156, which is incorporated herein by reference in it entirety]. The kinetic studies are also known to be able to assist the experimental data by providing insightful information about the adsorbent performance through the determination of adsorption rate, rate-limiting step, and well-understanding of the adsorption mechanism. Different kinetics models, namely: pseudo-first-order, pseudo-second-order [Ho, Y. S., 2006. Review of second-order models for adsorption systems. J. Hazard. Mater. 136, 681-689, which is incorporated herein by reference in its entirety], intra-particle diffusion, and liquid film diffusion, were used to determine rate-limiting step and adsorption mechanisms (FIG. 9). FIGS. 9A and 9B shows the kinetics studies of the BPA removal using pseudo-first-order and pseudo-second-order models. The correlation coefficient R2 observed from the pseudo-first-order model (Table 4A) is relatively higher than those of pseudo-second order for all tested polyimides except for 6FDA-DABA (Table 4B).

TABLE 4A
Pseudo-first-order kinetics parameters of
carboxyl-functionalized polyimides.

| | | | Pseudo-first-order | | |
|---|---|---|---|---|---|
| | Removal | | k₁ × 10⁻³ | q_{e cal} | |
| Adsorbent | (%) | q_{e exp} | (min⁻¹) | (mg g⁻¹) | R² |
| 6FDA-DABA | 88% | 17.6 | 12.67 | 12.9 | 0.88 |
| 6FDA-DABA/ | 75% | 15 | 4.606 | 14.5 | 0.99 |
| TrMCA(0.5/0.5) | | | | | |
| 6FDA-DABA/ | 42% | 8.5 | 1.152 | 8 | 0.93 |
| TrMCA(0.3/0.7) | | | | | |
| 6FDA-DABA/ | 12% | 2.4 | 2.303 | 2.2 | 0.94 |
| TrMCA(0.1/0.9) | | | | | |
| 6FDA-TrMCA | 2-3% | 0.4 | — | — | — |

TABLE 4B
Pseudo-second-order kinetics parameters of
carboxyl-functionalized polyimides.

| | | | Pseudo-second-order | | |
|---|---|---|---|---|---|
| | Removal | | k₁ × 10⁻³ | q_{e cal} | |
| Adsorbent | (%) | q_{e exp} | (min⁻¹) | (mg g⁻¹) | R² |
| 6FDA-DABA | 88% | 17.6 | 9.69 | 19.7 | 0.99 |
| 6FDA-DABA/ | 75% | 15 | 0.763 | 16.6 | 0.88 |
| TrMCA(0.5/0.5) | | | | | |
| 6FDA-DABA/ | 42% | 8.5 | 0.276 | 4.3 | 0.82 |
| TrMCA(0.3/0.7) | | | | | |
| 6FDA-DABA/ | 12% | 2.4 | 0.114 | 1.9 | 0.77 |
| TrMCA(0.1/0.9) | | | | | |
| 6FDA-TrMCA | 2-3% | 0.4 | — | — | — |

Additionally, the measured adsorbed quantity (qₑₓₚ) well matched with the calculated one (q_{cal}) from the pseudo-first-order model relative to those obtained from the pseudo-second-order, indicating that these polyimides better follow the pseudo-first-order model. However, the adsorption of BPA over 6FDA-DABA was best described by pseudo-second-order kinetics. The pseudo-second-order assumes that the rate-limiting step of BPA adsorption over the polyimides could be assisted by chemisorption through electron-sharing or exchange between the carboxyl-functionalized polyimides and BPA. However, in the case of 6FDA-TrMCA, low dispersion in the aqueous solution of BPA was observed, which is attributed to the hydrophobic surface leading to neglected adsorption, where no kinetics can be studied.

A direct correlation between adsorption and polymer wettability was found and presented in FIG. 9C. As the water contact angle increases, hydrophilicity decreases, leading to a significant reduction in the initial rate. It can be noted that 6FDA-TrMCA demonstrated the high BET surface area but revealed the lowest adsorption capacity of BPA. Although porosity is good for increasing the adsorption capacity, it seems that it is not the only factor that can affect it, especially in the presence of a predominant factor such as wettability. This behavior has been observed previously for a β-cyclodextrin polymer where low BET surface area polymers with high hydrophilicity displayed higher adsorption capacity relative to high BET surface area polymers with less hydrophilicity [Zhou, Y., Cheng, G., Chen, K., Lu, J., Lei, J., Pu, S., 2019. Adsorptive removal of bisphenol A, chloroxylenol, and carbamazepine from water using a novel β-cyclodextrin polymer. Ecotoxicol. Environ. Saf. 170, 278-285, which is incorporated herein by reference in its entirety]. This results shows that wettability will be the predominant factor when porosity and wettability are present in the same adsorbent. As shown in Table 5, the order of BPA removal efficiency followed the order of hydrophilicity in which 6FDA-DABA with the lowest contact angle of 77° displayed 88%. In comparison, 6FDA-TrMCA, with the highest contact angle of 96°, showed a 2-3% BPA removal efficiency.

TABLE 5
Diffusion kinetics parameters of carboxyl-functionalized polyimides.

| | Intra-particle | | | | |
|---|---|---|---|---|---|
| | diffusion model | | | | |
| | K_{d} × 10⁻³ | | Liquid film diffusion model | | |
| Adsorbent | (mg g⁻¹ min^{0.5}) | C | R² | D × 10⁻³ | R² |
| 6FDA-DABA | 61.5 | 7.66 | 0.65 | 12.6 | 0.88 |
| 6FDA-DABA/TrMCA | 58.3 | 1.97 | 0.96 | 4.3 | 0.99 |
| (0.5/0.5) | | | | | |
| 6FDA-DABA/TrMCA | 15.6 | 0.59 | 0.98 | 1.3 | 0.99 |
| (0.3/0.7) | | | | | |
| 6FDA-DABA/TrMCA | 5.7 | 0.0057 | 0.90 | 2.3 | 0.95 |
| (0.1/0.9) | | | | | |

To better understand the BPA adsorption mechanism over the carboxyl-functionalized polyimides, intra-particle diffusion (Weber-Morris model) and liquid film diffusion models were examined (FIGS. 9D and 9E and Table 5). FIG. 9D shows that 6FDA-DABA has the high adsorption quantity (qₜ) over different time intervals relative to the other copolyimides. Moreover, it is worth mentioning that 6FDA-DABA displayed the more considerable k_{d} value, showing easier diffusion of BPA to the polymer adsorbent. The higher C value was also obtained from 6FDA-DABA, reflecting a more significant contribution of surface adsorption in the rate-limiting step. As the ratio of TrMCA increases, the methyl group content increases, leading to an increase in hydrophobicity and a reduction in BPA adsorption quantity. This finding agrees with adsorption efficiency results and indicates that the BPA adsorption was more influenced by the hydrophilicity of the adsorbent and active sites (—COOH) than the BET surface area [Zhou, X., Wei, J., Liu, K., Liu, N., Zhou, B., 2014. Adsorption of bisphenol a based on synergy between hydrogen bonding and hydrophobic interaction. Langmuir 30, 13861-13868, which is incorporated herein by reference in its entirety].

Additionally, for the intra-particle diffusion, all polyimides displayed straight lines deviated from the origin, indicating that the internal particle diffusion (pore diffusion) is not the rate-limiting step and the adsorption is controlled by more than one type of diffusion process [Wu, H., Zhang, W., Zhang, H., Pan, Y., Yang, X., Pan, Z., Yu, X., Wang, D., 2020. Preparation of the novel g-C3N4 and porous polyimide supported hydrotalcite-like compounds materials for water organic contaminants removal. Colloids Surfaces A Physicochem. Eng. Asp. 607, 125517, which is incorporated herein by reference in its entirety]. Moreover, this deviation from the origin shows the presence of some boundary layer effect. Thus, the liquid film diffusion model was utilized to determine whether the external diffusion plays a critical role in the BPA adsorption process or not.

As shown in FIG. 9E and Table 5, all polyimides displayed higher R2 for the liquid film diffusion model than for the intra-particle diffusion model. Thus, the external film diffusion might be incorporated into the rate-limiting step and could be attributed to the wettability effect of the polyimide surfaces. The results suggests that external and internal diffusion plays a vital role in the rate-limiting step [Oyelude, E. O., Awudza, J. A. M., Twumasi, S. K., 2017. Equilibrium, Kinetic and Thermodynamic Study of Removal of Eosin Yellow from Aqueous Solution Using Teak Leaf Litter Powder. Sci. Rep. 7, which is incorporated herein by reference in its entirety].

To further evaluate the adsorption capacity of BPA on polyimides, Langmuir and Freundlich's models were investigated, and the obtained results are presented in FIG. 9F-FIG. 9I and Table 6.

TABLE 6
Langmuir and Freundlich isotherms parameters
of the carboxyl-functionalized polyimides

| | Langmuir model | | | | | |
|---|---|---|---|---|---|---|
| | Qₘₐₓ | | | Freundlich model | | |
| Adsorbent | (mg g⁻¹) | K_{L} | R² | K_{f} | n | R² |
| 6FDA-DABA | 67 | 0.13 | 0.95 | 13.87 | 2.57 | 0.93 |
| 6FDA-DABA/TrMCA | 37 | 0.25 | 0.90 | 14.08 | 4.39 | 0.75 |
| (0.5/0.5) | | | | | | |
| 6FDA-DABA/TrMCA | 11 | 0.19 | 0.93 | 4.01 | 4.24 | 0.78 |
| (0.3/0.7) | | | | | | |
| 6FDA-DABA/TrMCA | 8 | 0.03 | 0.97 | 0.57 | 1.91 | 0.97 |
| (0.1/0.9) | | | | | | |

The maximum adsorption capacities were achieved as follows: e.g., preferably about 67 mg g⁻¹ for 6FDA-DABA, e.g., preferably about 37 mg g⁻¹ for 6FDA-DABA/TrMCA (0.5/0.5), e.g., preferably about 11 mg g⁻¹ for 6FDA-DABA/TrMCA (0.3/0.7) and e.g., preferably about 8 mg g⁻¹ for 6FDA-DABA/TrMCA (0.1/0.9). The regression coefficient (R2) obtained by the Langmuir model of copolyimides 6FDA-DABA/TrMCA (0.5/0.5) and 6FDA-DABA/TrMCA (0.3/0.7) are relatively higher than those obtained from the Freundlich model, showing that the adsorption process here is best described by Langmuir adsorption mechanism. In other words, the BPA molecules are adsorbed homogeneously, forming monolayer coverage over copolymers where each molecule is adsorbed to one active site represented by the carboxylic acid group. On the other hand, both Langmuir and Freundlich models fit similarly to 6FDA-DABA and 6FDA-DABA/TrMCA (0.1/0.9), demonstrating that the BPA adsorption took place in both mono and multilayers coverage. These findings may be explained by the presence of active sites with different energy levels. All polyimide adsorbents show Freundlich 1/n values <1, suggesting a favorable adsorption process. However, 6FDA-DABA demonstrated superior performance for the BPA adsorption compared to other polymers in this series, regardless of its lower BET surface area. The present disclosure proves that porosity is not only a key parameter to enhancing the adsorption capacity, but wettability is more pronounced in this case.

To conclude, carboxyl-functionalized 6FDA-based copolyimides were prepared and tested for BPA removal along with their homopolymer counterparts. The present disclosure showed that porosity is not predominant in the presence of hydrophilicity and the polymer wettability is a critical parameter in enhancing adsorption capacity. The least porous and hydrophilic polyimide (i.e., 6FDA-DABA) demonstrated the highest maximum adsorption capacity of, e.g., preferably about 67 mg g 1 as obtained from the Langmuir isotherm model. The variation in methyl group substituents can significantly enhance the polymer porosity, but it reduces its removal efficiency, notably due to a reduction in hydrophilicity. The anti-synergistic regime between porosity and hydrophilicity was disclosed. Adsorption kinetics demonstrated that 6FDA-DABA follows the pseudo-second-order while all copolyimides follow the pseudo-first-order model. Fine-tuning polymer structure, functionalities, porosity, and wettability allow polyimides to contribute efficiently to various environmental remediation applications.

Numerous modifications and variations of the present disclosure are possible in light of the above teachings. It is therefore to be understood that within the scope of the appended claims, the invention may be practiced otherwise than as specifically described herein.

1. A method for separating bisphenol A (BPA) from an aqueous solution, comprising:
contacting an aqueous solution containing BPA with a polyimide polymer on a porous support; and
passing at least a portion of the aqueous solution through the polyimide polymer to form a purified water permeate and a BPA residue retentate, wherein the BPA residue retentate is present as a layer on an outside surface of the polyimide polymer;
wherein the polyimide polymer comprising reacted units of a fluorinated phthalic monomer and one or more amino carboxyl aryl monomers.

2. The method of claim 1, wherein the porous support is at least one selected from the group consisting of a polymeric support, a ceramic support, and a metallic support.

3. The method of claim 2, wherein the porous support is a ceramic support selected from the group consisting of an alumina support, a zirconia support, and a titania support.

4. The method of claim 1, wherein the polyimide polymer has a number average molecular weight (Mₙ) of 15 to 50 kilograms per mole (kg mol⁻¹) and a weight average molecular weight (Mw) of 15 to 60 kg mol⁻¹.

5. The method of claim 4, wherein the polyimide polymer is a polycondensate of 4,4′-(hexafluoroisopropylidene) diphthalic anhydride (6FDA) and 3,5-diaminobenzoic acid (DABA) (poly (6FDA-DABA)) and a polycondensate of 6FDA and 3,5-diamino-2,4,6-trimethylbenzoic acid (TrMCA) (poly (6FDA-TrMCA)).

6. The method of claim 1, wherein the polyimide polymer has a Mₙ of 80 to 120 kilograms per mole (kg mol⁻¹) and a Mw of 100 to 150 kg mol⁻¹.

7. The method of claim 6, wherein the polyimide polymer is a polycondensate of 6FDA, DABA and TrMCA (poly (6FDA-DABA/TrMCA)), and wherein a monomer ratio of the DABA to the TrMCA is in a range of 1:10 to 1:1.

8. The membrane of claim 1, wherein the BPA is present in the aqueous solution at a concentration of 0.5 to 5 milligrams per liter (mg/L) based on a total volume of the aqueous solution.

9. The method of claim 1, wherein the polyimide polymer has a water contact angle of 75 to 105 degrees (°).

10. The method of claim 1, wherein the polyimide polymer has a specific surface area of 30 to 300 square meters per gram (m² g⁻¹).

11. A method of making a polyimide membrane comprising a polyimide polymer, comprising:
mixing monomers of 6FDA, DABA, TrMCA and a first solvent in the presence of a base to form a reaction mixture;
heating the reaction mixture at a temperature of 180 to 220° C. thereby polymerizing monomers of 6FDA, DABA, and TrMCA to form the poly (6FDA-DABA/TrMCA) in the reaction mixture;
adding a second solvent to the reaction mixture to precipitate the poly (6FDA-DABA/TrMCA); and
removing the poly (6FDA-DABA/TrMCA) from the reaction mixture in the form a precipitate, washing and drying.

12. The method of claim 11, wherein a monomer ratio of the DABA to the TrMCA is in a range of 1:9 to 1:1.

13. The method of claim 11, wherein a ratio of the 6FDA monomer to a total monomers of the DABA and the TrMCA is in a range of 1:2 to 2:1.

14. The method of claim 11, wherein the first solvent is at least one selected from the group consisting of m-cresol, o-cresol, p-cresol, 3,4-xylenol, 2,6-xylenol, and 2,5-xylenol.

15. The method of claim 11, wherein the base is at least one selected from the group consisting of isoquinoline, quinoline, pyridine, piperidine, N-methylpyrrolidine, and 1,8-diazabicyclo[5.4.0]undec-7-ene (DBU).

16. The method of claim 11, wherein the second solvent is at least one selected from the group consisting of methanol, ethanol, n-propanol, i-propanol, n-butanol, and tert-butanol.

17. The method of claim 11, further comprising:
mixing and dissolving the poly (6FDA-DABA/TrMCA) in a third solvent to form a polymer solution;
applying the polymer solution onto a surface of a porous support to form a polymer layer in a liquid form on the porous support and drying to form the polyimide membrane;
wherein the polymer layer after the drying has an average thickness in a range of 5 to 100 micrometers (μm).

18. The method of claim 17, wherein the third solvent is at least one selected from the group consisting of dimethylformamide (DMF), dimethyl sulfoxide (DMSO), tetrahydrofuran (THF), and N-Methyl-2-pyrrolidone (NMP).

19. A water treatment method, comprising:
contacting a contaminated aqueous composition containing BPA with the polyimide membrane comprising a polyimide polymer prepared by the method of claim 11 to adsorb the BPA on the polyimide membrane and form a purified aqueous composition.

20. The method of claim 19, having a BPA removal efficiency of up to 90% based on an initial concentration of the BPA in the contaminated aqueous composition.
